(19) United States
(12) Patent Application Publication
(10) Pub. No.: US 2017/0285912 A1
(43) Pub. Date: Oct. 5, 2017

(54) METHODS, SYSTEMS, AND MEDIA FOR MEDIA GUIDANCE

(71) Applicant: Google Inc., Mountain View, CA (US)

(72) Inventors: Daniel Kaemmerer, San Bruno, CA (US); Clifford Curry, San Francisco, CA (US); Kansinee Adsanatham, San Francisco, CA (US); Natalie Johnston, San Bruno, CA (US); Sarah Hatem Ali, San Francisco, CA (US); Sana Mithani, San Bruno, CA (US); Venkat Rao, San Francisco, CA (US); Emmanuel Rene Saint-Loubert-Bie, Redwood City, CA (US); Toby Stewart Watson, San Francisco, CA (US); Paul John Thiel, Lafayette, CA (US)

(21) Appl. No.: 15/084,832

(22) Filed: Mar. 30, 2016

(51) Int. Cl. G06F 3/0484; G06F 3/0481

(52) U.S. Cl. CPC G06F 3/04842; G06F 3/0481

(57) ABSTRACT

Methods, systems, and media for providing media guidance are provided. In some embodiments, the method comprises: receiving a request to browse through related content; receiving a plurality of content clips, wherein each content clip corresponds to a portion of a corresponding content item; causing a first content clip to be presented; in response to determining that presentation of the first content clip has been completed, causing a second content clip to be presented; receiving a user input indicating a user preference related to the second content clip; in response to receiving the user input, requesting a third content clip based on the user preference related to the second content clip; receiving the third content clip, wherein the third content clip has been identified based at least in part on metadata associated with the second content clip and metadata associated with the third content clip; and causing the third content clip to be presented.

### TECHNICAL FIELD

The disclosed subject matter relates to methods, systems, and media for media guidance.

### BACKGROUND

Many users enjoy watching content such as television programs, live-streamed shows, movies, etc. However, it can be difficult and sometimes time consuming to determine which particular content item to begin watching. For example, a user may have trouble determining what a particular show is about and whether that user would be interested in viewing it based on title information, actor information, and program information. This is particularly problematic in instances where there are many content items to choose from.

Accordingly, it is desirable to provide new methods, systems, and media for media guidance.

### SUMMARY

Methods, systems, and media for media guidance are provided. In accordance with some embodiments of the disclosed subject matter, a method for media guidance is provided, the method comprising: receiving, from a user device, a request to browse through related content; receiving a plurality of content clips in response to receiving the request, wherein each content clip in the plurality of content clips corresponds to a portion of a corresponding content item, and wherein the plurality of content clips includes a first content clip and a second content clip that are each related to a particular topic; causing the first content clip to be presented on a display associated with the user device; in response to determining that presentation of the first content clip has been completed, causing the second content clip to be presented on the display associated with the user device; receiving, from the user device, a user input indicating a user preference related to the second content clip; in response to receiving the user input, requesting a third content clip based on the user preference related to the second content clip; receiving, in response to the request, the third content clip, wherein the third content clip has been identified based at least in part on metadata associated with the second content clip and metadata associated with the third content clip; and causing the third content clip to be presented on the display associated with the user device.

In accordance with some embodiments of the disclosed subject matter, a system for media guidance is provided, the system comprising: a hardware processor that is programmed to: receive, from a user device, a request to browse through related content; receive a plurality of content clips in response to receiving the request, wherein each content clip in the plurality of content clips corresponds to a portion of a corresponding content item, and wherein the plurality of content clips includes a first content clip and a second content clip that are each related to a particular topic; cause the first content clip to be presented on a display associated with the user device; in response to determining that presentation of the first content clip has been completed, cause the second content clip to be presented on the display associated with the user device; receive, from the user device, a user input indicating a user preference related to the second content clip; in response to receiving the user input, request a third content clip based on the user preference related to the second content clip; receive, in response to the request, the third content clip, wherein the third content clip has been identified based at least in part on metadata associated with the second content clip and metadata associated with the third content clip; and cause the third content clip to be presented on the display associated with the user device.

In accordance with some embodiments of the disclosed subject matter, non-transitory computer-readable media containing computer executable instructions that, when executed by a processor, cause the processor to perform a method for media guidance are provided. The method comprises: receiving, from a user device, a request to browse through related content; receiving a plurality of content clips in response to receiving the request, wherein each content clip in the plurality of content clips corresponds to a portion of a corresponding content item, and wherein the plurality of content clips includes a first content clip and a second content clip that are each related to a particular topic; causing the first content clip to be presented on a display associated with the user device; in response to determining that presentation of the first content clip has been completed, causing the second content clip to be presented on the display associated with the user device; receiving, from the user device, a user input indicating a user preference related to the second content clip; in response to receiving the user input, requesting a third content clip based on the user preference related to the second content clip; receiving, in response to the request, the third content clip, wherein the third content clip has been identified based at least in part on metadata associated with the second content clip and metadata associated with the third content clip; and causing the third content clip to be presented on the display associated with the user device.

In accordance with some embodiments of the disclosed subject matter, a system for media guidance is provided, the system comprising: means for receiving, from a user device, a request to browse through related content; means for receiving a plurality of content clips in response to receiving the request, wherein each content clip in the plurality of content clips corresponds to a portion of a corresponding content item, and wherein the plurality of content clips includes a first content clip and a second content clip that are each related to a particular topic; means for causing the first content clip to be presented on a display associated with the user device; in response to determining that presentation of the first content clip has been completed, means for causing the second content clip to be presented on the display associated with the user device; means for receiving, from the user device, a user input indicating a user preference related to the second content clip; in response to receiving the user input, means for requesting a third content clip based on the user preference related to the second content clip; means for receiving, in response to the request, the third content clip, wherein the third content clip has been identified based at least in part on metadata associated with the second content clip and metadata associated with the third content clip; and means for causing the third content clip to be presented on the display associated with the user device.

In some embodiments, a second content item corresponding to the second content clip and a third content item corresponding to the third content clip have been determined to be of similar durations.

In some embodiments, a second content item corresponding to the second content clip and a third content item corresponding to the third content clip have been determined to be associated with a particular genre of content based on the metadata associated with the second content clip and the metadata associated with the third content clip.

In some embodiments, the system further comprises: means for receiving, from the user device, a user input indicating selection of the third content clip; and in response to receiving the user input, means for causing a third content item associated with the third content clip to begin being presented on the display associated with the user device.

In some embodiments, the first content clip is requested based on a search query entered on the user device.

In some embodiments, the system further comprises: means for receiving, from the user device, a second user input indicating that the second content clip is not to be presented; in response to receiving the second user input, means for inhibiting presentation of the second content clip; and means for receiving, from the user device, a third user input indicating that presentation of the second content clip is to resume, wherein the second content clip is presented on the display associated with the user device in response to receiving the third user input.

In some embodiments, the system further comprises: means for receiving, from the user device, a request to modify a duration of the third content clip from a first duration to a second duration prior to causing the third content clip to be presented; in response to receiving the request, means for modifying the third content clip to be of the second duration; means for causing the modified third content clip to be presented on the display associated with the user device; and means for requesting a fourth content clip with the second duration.

### BRIEF DESCRIPTION OF THE DRAWINGS

Various objects, features, and advantages of the disclosed subject matter can be more fully appreciated with reference to the following detailed description of the disclosed subject matter when considered in connection with the following drawings, in which like reference numerals identify like elements.

FIGS. 1A and 1B show examples of user interfaces for presenting content clips in accordance with some embodiments of the disclosed subject matter.

FIG. 2 shows a schematic diagram of an example of a system for presenting a series of content clips in accordance with some embodiments of the disclosed subject matter.

FIG. 3 shows an example of hardware that can be used in a server and/or a user device in accordance with some embodiments of the disclosed subject matter.

FIG. 4 shows an example of an information flow diagram for identifying and presenting content clips in accordance with some embodiments of the disclosed subject matter.

FIG. 5 shows an example of a process for presenting content clips in accordance with some embodiments of the disclosed subject matter.

FIG. 6 shows an example of a process for identifying content clips in accordance with some embodiments of the disclosed subject matter.

### DETAILED DESCRIPTION

In accordance with various embodiments, mechanisms (which can include methods, systems, and media) for presenting a series of content clips are provided.

In some embodiments, the mechanisms described herein can cause a first content clip to be presented on a user device. In some embodiments, a content clip can correspond to a portion of a content item (e.g., the beginning of the content item, a middle portion of the content item, a portion of the content item determined to contain interesting content, and/or any other suitable portion). In some embodiments, the mechanisms can then identify one or more related content clips, and can cause the related content clips to be presented after the presentation of the first content clip on the user device, without receiving a user input.

In some embodiments, the content clips can be related in any suitable manner. For example, in some embodiments, the content clips can be related to a similar topic, belong to a similar genre of content (e.g., comedies, documentaries, music videos, and/or any other suitable genre), be associated with the same content type (e.g., high-definition video, and/or any other suitable content type), be included in the same collection of media content (e.g., a collection of media content aggregated by a particular user and/or content creator, episodic content, and/or any other suitable collection), and/or related in any other suitable manner, as described below.

In some embodiments, the mechanisms described herein can receive a user input that can modify or adjust a manner of presentation of the content clips. For example, in some embodiments, the user input can cause a change in the duration of the content clips, a change in the speed with which content clips are presented, audio content associated with the content clips to be muted or unmuted, a particular content clip to be skipped over, a previously presented content clip to be presented again, and/or changed in any other suitable manner. Note that, in some embodiments, the user input can be any suitable type of input (e.g., selection of a portion of a screen via a mouse, selection of a portion of a screen on a touchscreen, a voice input, and/or any other suitable type of input). In instances where the user input includes a voice input, the mechanisms can receive the voice input and decipher the received voice input to determine a corresponding command (e.g., a command indicating a manner in which presentation of the content clips is to be adjusted). For example, in some embodiments, the mechanisms can determine that the voice input indicates that a particular content clip is to be selected or skipped over, that a particular content clip was enjoyed by the user, that related content clips are to be presented, and/or any other suitable information. The mechanisms can then cause the corresponding command to be executed.

In some embodiments, the mechanisms described herein can receive a user selection of one of the content clips, and can cause a content item corresponding to the selected content clip to be presented on the user device.

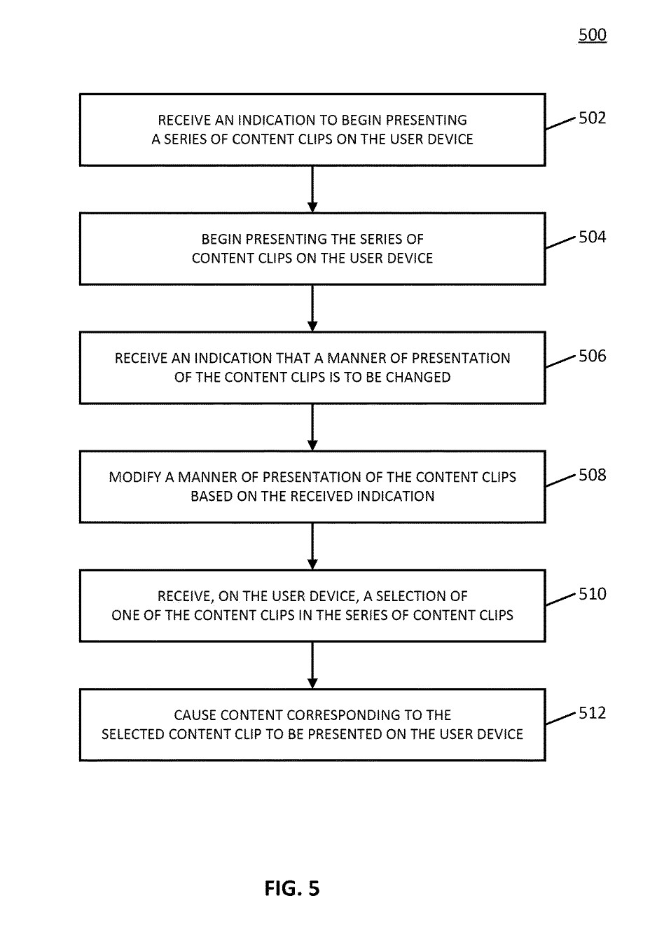

Note that, although the mechanisms are described herein as receiving user input(s) and presenting content clips on one user device, in some embodiments, the user input(s) can be received from a user device that is different from the user device that presents the content clips. For example, in some embodiments, a user input that causes a series of content clips to be presented (e.g., a user input that causes a browser to navigate to a particular web page, and/or any other suitable user input) can be received from a first user device (e.g., a mobile phone, a tablet computer, a laptop computer, a wearable computer, and/or any other suitable user device), and the series of content clips can be presented on a second user device (e.g., a television, a projector, a desktop computer, and/or any other suitable user device). As another example, in some embodiments, a user input that indicates a manner in which presentation of the content clips is to be adjusted can be received from the first user device, and presentation of the content clips can be adjusted on the second user device. In some embodiments, the first user device and the second user device can be associated and connected in any suitable manner, as described below in connection with FIG. 5.

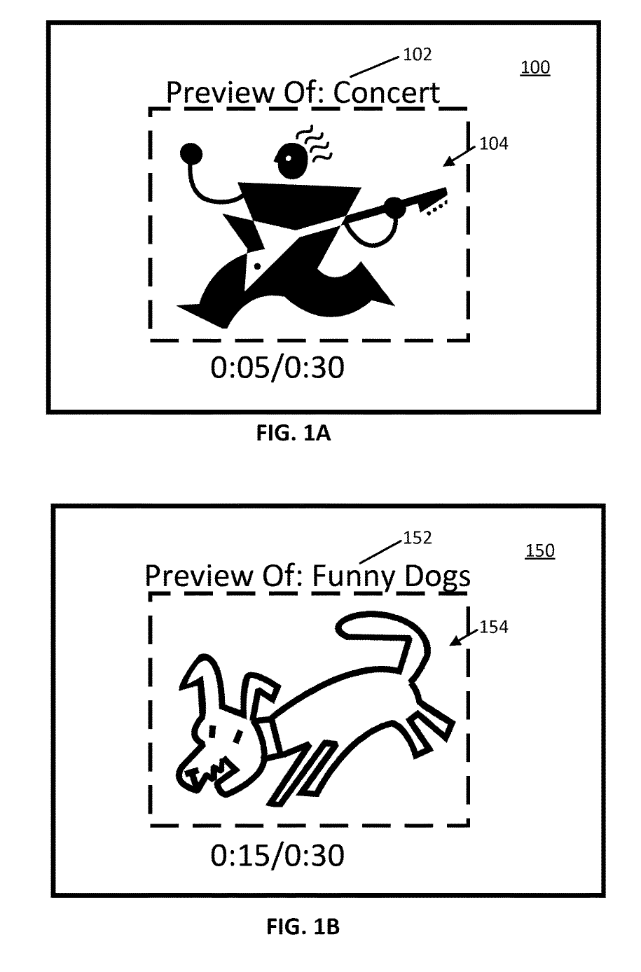

Turning to FIGS. 1A and 1B, examples 100 and 150 of user interfaces for presenting content clips are shown in accordance with some embodiments of the disclosed subject matter. As illustrated, user interfaces 100 and 150 can each include a content clip, such as content clips 104 and 154.

In some embodiments, content clips 104 and 154 can be any suitable portion of a content item, such as a video. For example, in some embodiments, content clips 104 and/or 154 can correspond to the beginning of the content item (e.g., the first N seconds, and/or any other suitable portion), a middle portion of the content item, and/or the end of the content item (e.g., the last N seconds, and/or any other suitable portion). In some embodiments, content clips 104 and/or 154 can have any suitable durations, and a duration of content clip 104 can be different than a duration of content clip 154. In some embodiments, titles 102 and/or 152 can be presented in connection with content clips 104 and/or 154, respectively. Titles 102 and/or 152 can indicate any suitable information, such as a name of a content item corresponding to content clip 104 and/or 154, a name of a creator of the corresponding content item, and/or any other suitable information.

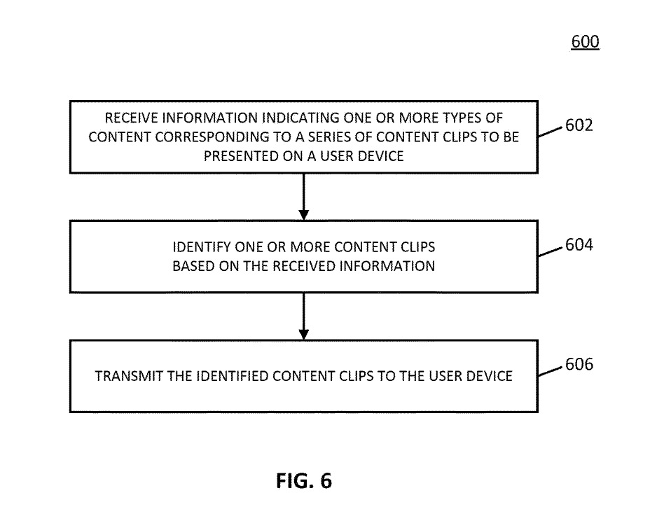

Note that, in some embodiments, a video can be analyzed and portions that are deemed to be interesting can be extracted from the video as content clips as described in more detail below in connection with FIG. 6. Additionally, in some embodiments, a content creator or other user can indicate portions of the video that cannot be extracted as a content clip. For example, to inhibit the presentation of spoiler content, certain portions of the video content can be identified as unsuitable for content clips, as described in more detail below in connection with FIG. 6.

In some embodiments, the content clips can have variable durations. For example, in some embodiments, a first content clip can have a first duration (e.g., five seconds, ten seconds, and/or any other suitable duration), and a second content clip can have a different, second duration. Note that, in some embodiments, a content clip can be selected based on a user-selected duration. For example, in some embodiments, a user can indicate that the user prefers content clips of a particular duration (e.g., five seconds, ten seconds, and/or any other suitable duration) as described below in connection with FIG. 5.

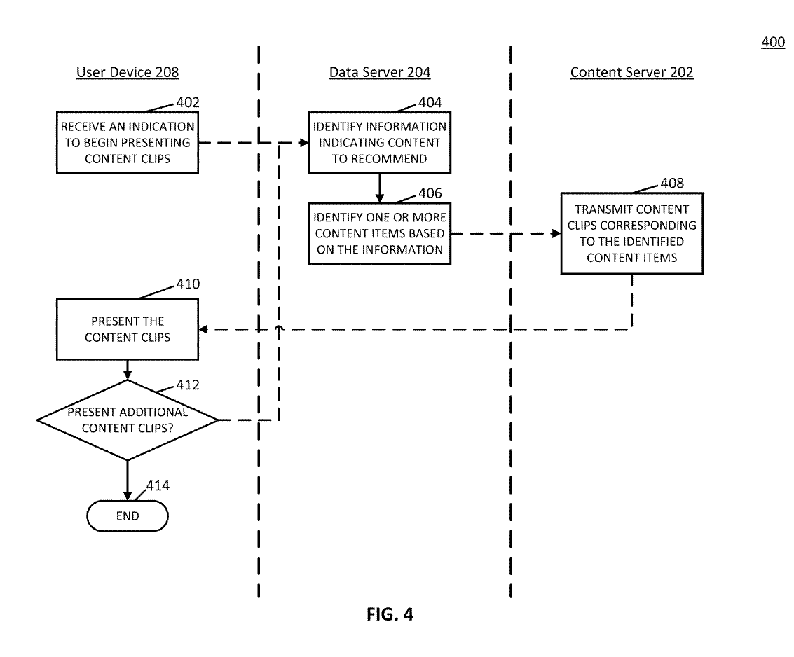

In some embodiments, content clip 104 can be presented, and, after presentation of content clip 104 has ended, presentation of content clip 154 can begin automatically without user input, as described below in connection with FIGS. 4 and 5. In some embodiments, content clips 104 and/or 154 can be related to each other in any suitable manner (e.g., associated with the same topic, created by the same content creator, associated with the same genre of content, and/or related in any other suitable manner), as described below in connection with FIG. 6. In some embodiments, input received from a user device can cause a manner of presentation of content clip 104 and/or 154 to be changed. For example, in some embodiments, the input can cause presentation of content clip 104 and/or 154 to be paused, can cause audio associated with content clip 104 and/or 154 to be muted or unmuted, and/or changed in any other suitable manner, as described below in connection with FIG. 5.

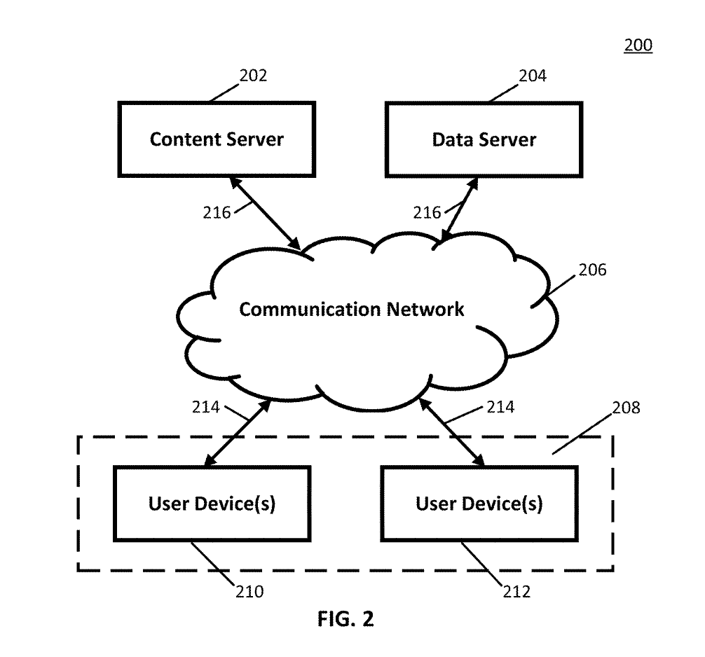

Turning to FIG. 2, an example 200 of hardware for presenting a series of content clips that can be used in accordance with some embodiments of the disclosed subject matter is shown. As illustrated, hardware 200 can include one or more servers, such as a content server 202, a data server 204, a communication network 206, and one or more user devices 208.

Content server 202 can be any suitable server for storing content items and/or content clips and delivering the content items and/or content clips to a user device 208 in some embodiments. For example, content server 202 can be a server that streams a series of content clips to user device 208 via communication network 206. As a more particular example, in some embodiments, content server 202 can stream content clips to user device 208 in response to receiving a request for the content clips from user device 208. Content provided by content server 202 can be any suitable content, such as video content, audio content, television programs, movies, cartoons, sound effects, audiobooks, web pages, news articles, streaming live content (e.g., a streaming radio show, a live concert, and/or any other suitable type of streaming live content), electronic books, search results and/or any other suitable type of content. Content can be created and uploaded to content server 202 by any suitable entity. In some embodiments, content server 202 can be omitted.

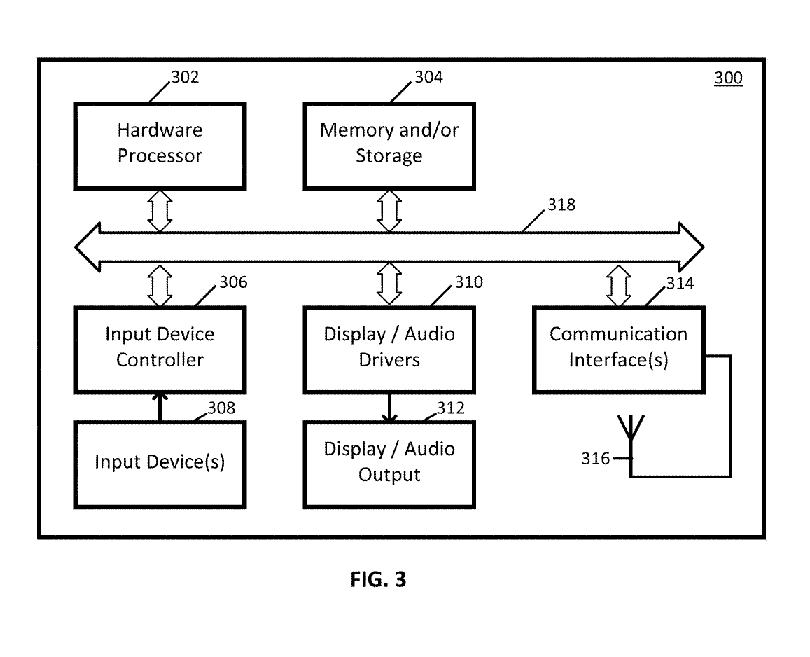

Data server 204 can be any suitable server for storing information related to a user's preferences for viewing clips of content. For example, in some embodiments, data server 204 can store information indicating the user's preferences for particular topics, particular genres of content (e.g., news, documentaries, movies, music videos, particular types of music, and/or any other suitable genres), particular durations of content clips (e.g., five seconds, thirty seconds, and/or any other suitable duration), collections of media content the user has subscribed to (e.g., collections of content associated with a particular television channel, a particular music group, a particular content creator, and/or any other suitable entity), and/or any other suitable preferences. In some embodiments, data server 204 can use the stored information to select one or more content clips to be presented on user device 208, as shown in and described below in connection with FIG. 3. In some embodiments, data server 204 can be omitted.

Communication network 206 can be any suitable combination of one or more wired and/or wireless networks in some embodiments. For example, communication network 206 can include any one or more of the Internet, a mobile data network, a satellite network, a local area network, a wide area network, a telephone network, a cable television network, a WiFi network, a WiMax network, and/or any other suitable communication network.

User device(s) 208 can include any one or more user devices suitable for presenting media content, presenting content clips, and/or performing any other suitable functions. For example, in some embodiments, user device(s) 208 can include mobile devices, such as a mobile phone, a tablet computer, a laptop computer, a vehicle (e.g., a car, a boat, an airplane, or any other suitable vehicle) entertainment system, a portable media player, or any other suitable mobile device. As another example, in some embodiments, user device(s) 208 can include non-mobile devices such as a desktop computer, a set-top box, a television, a streaming media player, a game console, or any other suitable non-mobile device.

Although content server 202 and data server 204 are illustrated as separate devices, any one or more of these devices can be combined into one device in some embodiments. Also, although only one each of content server 202 and data server 204 are shown in FIG. 2 to avoid over-complicating the figure, any suitable one or more of each device can be used in some embodiments.

Although only one user device 208 is shown in FIG. 2 to avoid over-complicating the figure, any suitable number of each of these devices, and any suitable types of these devices, can be used in some embodiments.

Content server 202, data server 204, and user device 208 can be implemented using any suitable hardware in some embodiments. For example, in some embodiments, devices 202, 204, and 208 can be implemented using any suitable general purpose computer or special purpose computer. For example, a server may be implemented using a special purpose computer. Any such general purpose computer or special purpose computer can include any suitable hardware. For example, as illustrated in example hardware 300 of FIG. 3, such hardware can include hardware processor 302, memory and/or storage 304, an input device controller 306, an input device 308, display/audio drivers 310, display and audio output circuitry 312, communication interface(s) 314, an antenna 316, and a bus 318.

Hardware processor 302 can include any suitable hardware processor, such as a microprocessor, a micro-controller, digital signal processor(s), dedicated logic, and/or any other suitable circuitry for controlling the functioning of a general purpose computer or a special purpose computer in some embodiments.

Memory and/or storage 304 can be any suitable memory and/or storage for storing programs, data, media content, and/or any other suitable information in some embodiments. For example, memory and/or storage 304 can include random access memory, read-only memory, flash memory, hard disk storage, optical media, and/or any other suitable memory.

Input device controller 306 can be any suitable circuitry for controlling and receiving input from one or more input devices 308 in some embodiments. For example, input device controller 306 can be circuitry for receiving input from a touch screen, from one or more buttons, from a voice recognition circuit, from a microphone, from a camera, from an optical sensor, from an accelerometer, from a temperature sensor, from a near field sensor, and/or any other type of input device.

Display/audio drivers 310 can be any suitable circuitry for controlling and driving output to one or more display/audio output circuitries 312 in some embodiments. For example, display/audio drivers 310 can be circuitry for driving an LCD display, a speaker, an LED, or any other type of output device.

Communication interface(s) 314 can be any suitable circuitry for interfacing with one or more communication networks, such as network 306 as shown in FIG. 3. For example, interface(s) 314 can include network interface card circuitry, wireless communication circuitry, and/or any other suitable type of communication network circuitry.

Antenna 316 can be any suitable one or more antennas for wirelessly communicating with a communication network in some embodiments. In some embodiments, antenna 316 can be omitted when not needed.

Bus 318 can be any suitable mechanism for communicating between two or more components 302, 304, 306, 310, and 314 in some embodiments.

Any other suitable components can be included in hardware 300 in accordance with some embodiments.

Turning to FIG. 4, an example 400 of an information flow diagram for identifying and presenting a series of content clips is shown in accordance with some embodiments of the disclosed subject matter. As illustrated, blocks of information flow diagram 400 can be executed on user device 208, data server 204, and/or content server 202.

User device 208 can begin by receiving an indication to begin presenting a series of content clips at 402. The indication can be received based on any suitable information. For example, in some embodiments, user device 208 can receive an input from an input device associated with user device 208 (e.g., from a keyboard, from a touchscreen, from a microphone, and/or from any other suitable input device). As another example, in some embodiments, user device 208 can receive the indication based on a determination that user device 208 has finished presenting a content item and is to begin presenting a series of content clips after presentation of the content item has finished.

Data server 204 can identify information indicating content to be included in the series of content clips at 404. For example, in some embodiments, data server 204 can identify one or more user preferences associated with a user account authenticated on user device 208. As a more particular example, in some embodiments, the user preferences can indicate information identifying content likely to be enjoyed by the user. As a specific example, in some embodiments, the type of content can indicate a genre of content (e.g., comedy shows, documentaries, music videos, and/or any other suitable genre(s)), a type of content (e.g., live-streamed content, music videos, high-definition content, and/or any other suitable types of content), one or more topics determined to be of interest (e.g., a name of a particular television show, a name of a particular music group, a hobby, and/or any other suitable topics), a duration of content preferred by the user (e.g. longer than one hour, less than five minutes, between thirty and forty minutes, and/or any other suitable duration), and/or any other suitable information related to the content. As another example, in some embodiments, data server 204 can identify any other suitable information, such as content previously viewed on user device 208, collections of content the user has subscribed to, and/or any other suitable information.

Data server 204 can identify one or more content items based on the information at 406. For example, in some embodiments, data server 204 can identify one or more content items related to a similar topic, created by the same content creator, belonging to the same genre, and/or any other suitable content items. Data server 204 can identify any suitable number (e.g., one, two, five, ten, and/or any other suitable number) of content items.

At 408, content server 202 can identify and transmit content clips corresponding to the content items identified at block 406. In some embodiments, data server 204 can transmit any suitable identifiers corresponding to the content items, and content server 202 can retrieve the content clips based on the identifiers. For example, in some embodiments, the identifiers can indicate a name of the content item, an identification number or string associated with the content item, an address (e.g., a Universal Resource Locator, or URL) associated with the content item, and/or any other suitable identifying information. In some embodiments, the content clip retrieved by content server 202 can correspond to any suitable portion of the content item (e.g., the beginning, the middle, the end, and/or any other suitable portion) and can be of any suitable duration (e.g., one second, five seconds, thirty seconds, and/or any other suitable duration). Note that, in some embodiments, a duration of each content clip can be different. In some embodiments, content server 202 can then transmit the one or more content clips to user device 208.

Note that, in some embodiments, content server 202 can identify the portion of the content item to be used for the content clip in any suitable manner. For example, in some embodiments, content server 202 can, by default, use the first N seconds (e.g., first five seconds, first thirty seconds, and/or any other suitable duration) of the content item to create the content clip. As another example, in some embodiments, content server 202 can use any suitable techniques to identify a relatively interesting portion of the content item. As a more particular example, in some embodiments, content server 202 can identify one or more portions of the content item that do not include commercials, that include scenes in which particular characters are present, and/or any other suitable portions, as described in more detail below in connection with FIG. 6. Note that, in some embodiments, a content clip can include multiple non-continuous portions of the content item stitched together into a content clip (e.g., frames 5-50 and frames 80-120, and/or any other suitable portions).

At 410, user device 208 can cause the received content clips to be presented. In some embodiments, user device 208 can cause a first content clip to be presented, and, in response to determining that presentation of the first content clip has finished, cause a second content clip to automatically be presented without user input. In some embodiments, user device 410 can cause a series of any suitable number of content clips to be presented. Note that, in some embodiments, an advertisement can be presented at any suitable time. For example, in some embodiments, advertisements can be presented between two content clips and/or in the middle of a content clip. As another example, in some embodiments, advertisements can be presented before and/or after a content clip. Additionally, note that, in some embodiments, user device 208 can cause the content clips to be presented on a display device associated with user device 208, such as an associated television, projector, desktop computer, tablet computer, and/or any other suitable display device.

At 412, user device 208 can determine whether additional content clips are to be presented. For example, in some embodiments, user device 208 can determine whether user device 208 has received an input indicating selection of one of the content clips, and, if the input has been received, determine that no additional content clips are to be shown.

If, at 412, it is determined that additional content clips are to be presented (“yes” at 412), information flow diagram can loop back to block 404.

If, at 412, it is determined that no additional content clips are to be presented (“no” at 412), information flow diagram 400 can end at 414.

Turning to FIG. 5, an example 500 of a process for presenting a series of content clips on a user device is shown in accordance with some embodiments of the disclosed subject matter.

Process 500 can begin by receiving an indication to begin presenting a series of content clips on the user device at 502. As described above in connection with block 402 of FIG. 4, the indication can be received in any suitable manner. For example, in some embodiments, the indication can be received based on selection of a particular input on the user device. As a more particular example, in some embodiments, the selected input can correspond to a user selection indicating that scanning through a series of content items is to begin. As another example, in some embodiments, the indication can be received based on a determination that the user device has finished presenting a content item and that one or more content clips are to begin being presented without user input. In some embodiments, content items in the series of content items can be associated with any suitable variety of content providers, topics, genres, etc.

Process 500 can receive one or more content clips (e.g., from content server 202 as shown in and described above in connection with FIG. 4) and can begin presenting the content clips on the user device at 504, for example, as shown in and described above in connection with FIGS. 1A and 1B. In some embodiments, process 500 can cause a first content clip to be presented, and, in response to determining that presentation of the first content clip has finished, can cause a second clip to begin being presented without user input. In some such embodiments, process 500 can cause any suitable number (e.g., two, five, ten, twenty, and/or any other suitable number) of content clips to be presented. In some embodiments, process 500 can continue presenting content clips until a particular user input is received from the user device indicating that content clips are to no longer be presented. For example, in some embodiments, the user input can indicate selection of one of the presented content clips, and, in response to receiving the user input, process 500 can stop presenting content clips and can begin presenting a content item associated with the selected content clip.

Note that, in some embodiments, process 500 can cause the content clips to be presented on a display device associated with the user device. For example, in some embodiments, the user device can be associated with a display device (e.g., a television, a projector, speakers, a laptop computer, a tablet computer, a desktop computer, and/or any other suitable device), and process 500 can cause the content clips to be presented on the display device. In some such embodiments, user inputs that cause presentation of the content clips to stop can be received from the user device and/or from the associated display device. In some embodiments, the user device can discover the display device using any suitable technique or combination of techniques, such as multicasting a message to a particular address on the network and launching an event listener to listen for replies from devices on the network that received the multicast message. In some such embodiments, the user device can discover devices in response to the user device launching a particular application, in response to a particular user input (e.g., a user input to begin presenting a series of content clips, a user input that causes a browser window to navigate to a particular web page, and/or any other suitable user input), periodically, and/or at any other suitable time.

In some embodiments, process 500 can cause the content clips to be presented on the display device associated with the user device using any suitable technique or combination of techniques. For example, in some embodiments, the user device can transmit instructions to the display device indicating the content clips to be presented. As a more particular example, in some embodiments, the instructions can include one or more Uniform Resource Locators (URLs) indicating locations at which the content clip(s) are stored. As another example, in some embodiments, the user device can transmit the content clips to the display device via any suitable communication network (e.g., a WiFi network, a BLUETOOTH network, and/or any other suitable network). Additionally or alternatively, in some embodiments, the user device can send the content clips to the display device via a secure communication channel established between the user device and the display device. In some embodiments, any suitable protocol can be used to transfer data associated with the content clips from the user device to the display device, such as adaptive bitrate streaming, HTTP live streaming, user datagram protocol (UDP), and/or any other suitable protocol(s). The display device can then cause the content clip(s) to be presented on the display device.

Process 500 can receive an indication that a manner of presentation of the content clips is to be changed at 506. In some embodiments, process 500 can receive the indication based on a user input from the user device. In some embodiments, the presentation can be changed in any suitable manner. For example, in some embodiments, process 500 can cause audio content associated with a content clip to be muted or unmuted. As another example, in some embodiments, process 500 can cause each content clip to be of a shorter or longer duration. As a more particular example, in instances where each content clip is five seconds long, process 500 can cause subsequent content clips to be shorter (e.g., two seconds, three seconds, and/or any other shorter duration) or longer (e.g., ten seconds, twenty seconds, and/or any other longer duration) based on the received indication. As yet another example, in some embodiments, a received user input can cause a particular content clip to be skipped over and/or to cause a previously presented content clip to be presented again. As still another example, in some embodiments, a received user input can cause presentation of a content clip to be paused.

Note that, in some embodiments, process 500 can receive any suitable user inputs indicating desired content associated with the content clips. For example, in some embodiments, the user input can indicate that a user of the user device enjoyed a particular content clip. Process 500 can then cause content clips related to similar content (e.g., related to a similar topic, created by the same content creator, and/or related in any other suitable manner) to be presented, for example, by transmitting an indication that the user enjoyed the content clip to content server 202 and/or data server 204, and receiving one or more similar content clips. As another example, in some embodiments, the user input can indicate that a user of the user device did not enjoy a particular content clip. Process 500 can then identify and/or request content clips related to different content (e.g., related to a different topic, created by a different content creator, and/or related to content that is dissimilar in any other suitable manner). Additionally or alternatively, in some embodiments, process 500 can inhibit presentation of content clips related to the content that the user indicated the user did not enjoy (e.g., content related to similar topics, content created by the same content creator, and/or related in any other suitable manner). As yet another example, in some embodiments, the user input can indicate that the user does not want to view content clips corresponding to content items the user has previously viewed. As yet another example, in some embodiments, the user input can indicate a content rating (e.g., G, PG, PG-13, R, NC-17, and/or any other suitable content rating) associated with the content clips. As a more particular example, in some embodiments, the user input can indicate that content clips associated with particular content ratings are not to be shown.

At 508, process 500 can modify the manner of presentation of the content clips based on the received indication. For example, in instances where process 500 determines, based on the received indication, that a duration of content clips is to be changed, process 500 can determine a new duration (e.g., longer than or shorter than a previous duration) and can cause the content clips to be presented with the new duration. As another example, in instances where process 500 received a user input to mute or unmute audio content associated with the content clips, process 500 can correspondingly stop or initiate presentation of the associated audio content.

Note that, in instances where process 500 modifies a duration of the content clips, the duration can be modified in any suitable manner. For example, in instances where the user input indicates that a duration of the content clips is to be shortened, process 500 can select any suitable portion of the content clip corresponding to the shortened duration for presentation. As another example, in instances where the user input indicates that a duration of the content clips is to be lengthened, process 500 can generate a new content clip from the corresponding content item that is of the lengthened duration. In some embodiments, process 500 can request additional content clips of the new duration, for example, from content server 202. Note that, in some embodiments, process 500 can cause content clips that have already been received by the user device to be presented (with or without modification of a duration of the received content clips) and can request additional content clips of the new duration.

Additionally, note that, in some embodiments, information indicating how a duration of a content clip can be modified can be stored in association with the content clip. For example, in some embodiments, the information can indicate whether a particular content clip can be cropped and/or shortened. As a more particular example, in instances where a particular content clip has a duration of ten seconds, the information can indicate whether the content clip can be cropped to a particular duration shorter than ten seconds (e.g., five seconds, seven seconds, and/or any other suitable duration). As a specific example, in some embodiments, the stored information can indicate that a content clip with a duration of ten seconds can be cropped to have a duration of at least five seconds. Additionally, in some embodiments, the information can indicate suitable portions of the content clip to be included in a cropped version of the content clip. For example, in some embodiments, the information can indicate particular frames and/or time points of the content clip to be used for content clips of different durations. As a specific example, in some embodiments, the information can indicate that the portion of the content clip between 0:05 to 0:10 can be used to generate a content clip with a five second duration. Additionally or alternatively, in some embodiments, the stored information can indicate that a particular content clip cannot be cropped and/or shortened. In some such embodiments, in response to receiving a user input indicating that the user wants content clips with a shortened duration, process 500 can retrieve the stored information and determine that new content clips are to be generated with the shortened duration and/or that new content clips of the shortened duration are to be retrieved (e.g., from content server 202).

Process 500 can receive a selection of one of the content clips at 510. In some embodiments, the selection can be received from any suitable input device associated with the user device, such as a touchscreen of a mobile device, a keyboard, a mouse, a remote control, and/or any other suitable input device. In some embodiments, the input device can be part of the user device (e.g., in instances where the user device is a mobile device and the input device is a touchscreen). Additionally or alternatively, in some embodiments, the input device can be associated with the user device in any suitable manner. For example, in some embodiments, the input device can be associated with the user device via a BLUETOOTH connection, a Wi-Fi connection, a cable, and/or any other suitable type of connection.

Process 500 can cause content corresponding to the selected content clip to be presented at 512. For example, in some embodiments, process 500 can cause a content item corresponding to the selected content clip to be presented from the beginning of the content item. In some embodiments, process 500 can cause the content item to be presented on the user device. Additionally or alternatively, in some embodiments, process 500 can cause the content item to be presented on a display device associated with the user device, such as a television, projector, and/or any other suitable display device, as described above.

Turning to FIG. 6, an example 600 of a process for identifying one or more content clips is shown in accordance with some embodiments of the disclosed subject matter. In some embodiments, blocks of process 600 can be implemented on content server 202 and/or data server 204.

Process 600 can begin by receiving information indicating one or more types of content corresponding to a series of content clips to be presented on a user device. For example, in some embodiments, the information can indicate a genre, topic, or type of content. As a more particular example, in some embodiments, the information can indicate a genre (e.g., comedy shows, news shows, documentaries, and/or any other suitable genre of content) or topic (e.g., a name of a particular television show, a name of a particular music group, a hobby, and/or any other suitable topic information) of content determined to be of interest to the user. As another more particular example, in some embodiments, the information can indicate a type of content (e.g., music videos, live-streaming content, high-definition videos, and/or any other suitable type of content) determined to be of interest to the user. As another example, in some embodiments, the information can indicate a duration of content (e.g., less than five minutes, more than two hours, between thirty and forty minutes, and/or any other suitable duration or range) determined to be preferred by the user. As yet another example, in some embodiments, the information can indicate collections of media content a user of the user device has subscribed to and/or indicated enjoyment of. As a more particular example, in some embodiments, the collection of media content can include content aggregated by any suitable entity (e.g., a television channel, a music group, a particular content creator, another user, and/or any other suitable entity). As still another example, in some embodiments, the information can indicate information related to the user of the user device, such as content the user has previously selected, demographic information associated with a user account authenticated on the user device, a current location of the user device (e.g., determined by an Internet Protocol address, determined by Global Positioning System coordinates, determined by settings explicitly set by the user, and/or determined in any other suitable manner), and/or any other suitable information.

Note that, in some embodiments, process 600 can receive information from any suitable source. For example, in some embodiments, information indicating content preferences, topics of interest, previously viewed content, and/or any other information related to a user of the user device can be identified based on a user account authenticated on the user device. In some such embodiments, permission to access the information can be requested from the user. As a more particular example, in some embodiments, consent to store and/or use the information can be set using, for example, a settings user interface associated with the user account. Additionally, in some embodiments, permissions can be changed and/or modified at any suitable time by the user.

Process 600 can identify one or more content clips based on the received information at 604. For example, in some embodiments, process 600 can identify one or more content clips based on genres, topics, and/or types of content determined to be of interest to the user. As another example, in some embodiments, process 600 can identify one or more content clips based on collections of media content a user of the user device has subscribed to and/or indicated enjoyment of In some embodiments, two or more of the identified content clips can be related to each other in any suitable manner. For example, in some embodiments, the content clips can be associated with a similar topic, belong to the same genre of content, be a similar type of content (e.g., high-definition video, music videos, and/or any other suitable content type), be of a similar duration, and/or be similar in any other suitable manner.

In some embodiments, the content clips can be generated at any suitable time and stored (e.g., in memory 304 of content server 202) for later use. For example, in some embodiments, content server 202 can generate a content clip corresponding to a recently uploaded video, and can store the generated content clip until process 600 determines that the content clip is to be presented on the user device. In some such embodiments, content clips can be generated for any suitable content items (e.g., all content items, content items with more than a predetermined number of views, content items associated with a particular content creator or entity, and/or any other suitable content items). As another example, in some embodiments, a content clip can be dynamically generated for a content item in response to process 600 determining that a content clip corresponding to a particular content item is to be presented.

In some embodiments, a content clip can be generated using any suitable technique or combination of techniques. For example, in some embodiments, a content clip can correspond to the beginning or end of a content item (e.g., the first N seconds of the content item, the last N seconds of the content item, and/or any other suitable portion). As another example, in some embodiments, the content clip can correspond to any suitable portion in the middle of the content item. Note that, in some embodiments, the content clip can include any suitable number of non-continuous portions of the content item.

In some embodiments, the content clip can include portions of the content item determined to be of particular interest, such as portions that do not include commercials, portions that include one or more particular characters or people, portions that include one or more particular locations or scenes, and/or any other suitable portions. In some embodiments, any suitable techniques (e.g., object recognition, visual scene processing, machine learning techniques, and/or any other suitable techniques) can be used to identify particular portions of the content item to be included in the content clip. For example, in some embodiments, the content item can be analyzed to find one or more breaks in a video segment and/or audio segment associated with the content item that correspond to a commercial break, and a content clip can be generated that does not include portions of the content item that correspond to the commercial break. As another example, in some embodiments, a beginning portion (e.g., the first N frames or seconds of the content item) and/or an ending portion (e.g., the last M frames or seconds of the content item) of the content item can be excluded from a content clip and/or removed from the content item to generate the content clip. As a more particular example, in some embodiments, the first N frames of the content item can correspond to an opening screen of the content item which can be excluded from the content clip. As another more particular example, in some embodiments, the last M frames of the content item can correspond to an end screen of the content item which can be excluded from the content clip.

As another example, in some embodiments, activity related to the content item on one or more social networking sites can be used to identify portions of the content item deemed to be of interest and that are to be included in the content clip. As a more particular example, in some embodiments, comments posted on a social networking site (e.g., in a post on the social networking site, on a page associated with the content item on a social networking site and/or a video sharing site, and/or any other suitable comment) can be identified, and text of the comment that indicates a particular portion of the content item can be identified. Text of the comment can be correlated with portions of the content item in any suitable manner, for example, by comparing text of the comment with captions of the content item (e.g., to identify quotations of dialogue in the content item included in the text of the content), by identifying characters and/or actors mentioned in the comment and identifying scenes in the content item that include those characters and/or actors, and/or in any other suitable manner. In some such embodiments, the content clip can then be generated to include the identified portions of the content item. As another more particular example, in some embodiments, a particular time point within the content item at which a relatively high number of social media posts were created referencing the content item can be identified, and a content clip that includes the particular time point can be generated. As a specific example, in instances where the content item corresponds to an event (e.g., a debate, a speech, a sports event, a concert, and/or any other suitable type of event), a time point within a broadcast of the event at which more than a predetermined number of posts on a social networking site referencing the event can be identified, and a content clip that includes the identified time point can be created. As yet another more particular example, in some embodiments, a particular time point and/or time range within the content item at which a relatively high number of comments are associated can be identified, and the content clip can be generated to include content from the identified time point and/or time range. As a specific example, in some embodiments, a time point and/or time range associated with the content item can be identified at which more than a predetermined number of comments have been posted on a video sharing site that hosts the content item.

Note that, in some embodiments, particular portions of a content item can be inhibited from being included in a content clip. For example, in some embodiments, the particular portions of the content item can include spoiler content that indicates an ending and/or an outcome of the content item. In some embodiments, the particular portions of the content item that are not to be included in a content clip can be identified in any suitable manner. For example, in some embodiments, a content creator associated with the content item can indicate the portions of the content item that are not to be included. As a more particular example, in some embodiments, the content creator can indicate particular time points within the content item that correspond to content that is not to be included in the content clip (e.g., between frames 50 and 100, between time points 2:00 and 6:00, and/or any other suitable time indications). Note that, in some embodiments, any other suitable user can indicate portions of the content item that include spoiler content.

As another example, in some embodiments, the particular portions of the content item not to be included in a content clip can be identified based on metadata associated with the content item. As a more particular example, in some embodiments, the metadata can indicate a type of content (e.g., episodic content, a sports event, an episode of a reality television series, and/or any other suitable type of content) associated with the content item. In some such embodiments, portions of the content item not to be included in a content clip can be determined based on the type of content. As a specific example, in instances where the type of content corresponds to episodic content and/or an episode of a reality television series, content clips can be generated that do not include portions of the content item that occur at the end of the content item (e.g., the last five minutes, the last two minutes, and/or any other suitable portions) and/or portions that occur before a commercial break (e.g., the minute before a commercial break, and/or any other suitable portions). As another specific example, in instances where the type of content corresponds to a sports event, content clips can be generated that do not include portions of the content item that occur at the end of the sports event (e.g., the last five minutes, and/or any other suitable time period).

In some embodiments, process 600 can use a user input to select content clips. For example, in some embodiments, the user input can include an indication of a particular topic, genre, content creator, and/or any other suitable indication of content. As a more particular example, in some embodiments, the user input can include text (e.g., a name of a music group, text indicating a topic and/or genre, and/or any other suitable text). As another more particular example, in some embodiments, the user input can include a search query that can be used to find one or more search results corresponding to content items. As another example, in some embodiments, the user input can include a selection of a particular video (indicating that the user wants to a see a clip and/or a preview associated with the video) and/or a selection of a particular collection of media content (e.g., a channel of media content, a playlist of media content, and/or any other suitable collection of media content). In some embodiments, process 600 can use the user input to select a first content clip and can subsequently select one or more other content clips based on the selected first content clip. For example, in some embodiments, process 600 can select content clips related to the first content clip based on any suitable information, such as metadata indicating a topic of the first content clip, a creator of the first content clip, a collection of media content to which the first content clip belongs, a genre associated with the first content clip, a type of content associated with the content clip, and/or any other suitable information.

Note that, in some embodiments, process 600 can identify one or more content clips based on any other suitable information. For example, in some embodiments, process 600 can identify the content clips based on a determined popularity of various content items. As a more particular example, in some embodiments, process 600 can identify one or more content items that are determined to be relatively popular (e.g., have received more than a predetermined number of views and/or comments, have received more than a predetermined number of views within a predetermined time period, and/or determined based on any other suitable metric), and can select content clips corresponding to the identified content items.

Process 600 can transmit the identified content clips to the user device at 606. Process 600 can use any suitable technique or combination of techniques to transmit the identified content clips to the user device. For example, in some embodiments, process 600 can transmit data corresponding to the identified content clips to the user device via communication network 206, and can cause the content clips to be streamed on the user device.

It should be understood that at least some of the above described blocks of the processes of FIGS. 4-6 can be executed or performed in any order or sequence not limited to the order and sequence shown in and described in the figure. Also, some of the above blocks of the processes of FIGS. 4-6 can be executed or performed substantially simultaneously where appropriate or in parallel to reduce latency and processing times. Additionally or alternatively, some of the above described blocks of the processes of FIGS. 4-6 can be omitted.

In some embodiments, any suitable computer readable media can be used for storing instructions for performing the functions and/or processes herein. For example, in some embodiments, computer readable media can be transitory or non-transitory. For example, non-transitory computer readable media can include media such as magnetic media (such as hard disks, floppy disks, and/or any other suitable magnetic media), optical media (such as compact discs, digital video discs, Blu-ray discs, and/or any other suitable optical media), semiconductor media (such as flash memory, electrically programmable read-only memory (EPROM), electrically erasable programmable read-only memory (EEPROM), and/or any other suitable semiconductor media), any suitable media that is not fleeting or devoid of any semblance of permanence during transmission, and/or any suitable tangible media. As another example, transitory computer readable media can include signals on networks, in wires, conductors, optical fibers, circuits, any suitable media that is fleeting and devoid of any semblance of permanence during transmission, and/or any suitable intangible media.

In situations in which the systems described here collect personal information about users, or make use of personal information, the users may be provided with an opportunity to control whether programs or features collect user information (e.g., information about a user's social network, social actions or activities, profession, a user's preferences, or a user's current location). In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over how information is collected about the user and used by a content server.

Accordingly, methods, systems, and media for media guidance are provided.

Although the invention has been described and illustrated in the foregoing illustrative embodiments, it is understood that the present disclosure has been made only by way of example, and that numerous changes in the details of implementation of the invention can be made without departing from the spirit and scope of the invention, which is limited only by the claims that follow. Features of the disclosed embodiments can be combined and rearranged in various ways.

What is claimed is:

1. A method for media guidance, comprising:
receiving, from a user device, a request to browse through related content;
receiving a plurality of content clips in response to receiving the request, wherein each content clip in the plurality of content clips corresponds to a portion of a corresponding content item, and wherein the plurality of content clips includes a first content clip and a second content clip that are each related to a particular topic;
causing the first content clip to be presented on a display associated with the user device;
in response to determining that presentation of the first content clip has been completed, causing the second content clip to be presented on the display associated with the user device;
receiving, from the user device, a user input indicating a user preference related to the second content clip;
in response to receiving the user input, requesting a third content clip based on the user preference related to the second content clip;
receiving, in response to the request, the third content clip, wherein the third content clip has been identified based at least in part on metadata associated with the second content clip and metadata associated with the third content clip; and
causing the third content clip to be presented on the display associated with the user device.

2. The method of claim 1, wherein a second content item corresponding to the second content clip and a third content item corresponding to the third content clip have been determined to be of similar durations.

3. The method of claim 1, wherein a second content item corresponding to the second content clip and a third content item corresponding to the third content clip have been determined to be associated with a particular genre of content based on the metadata associated with the second content clip and the metadata associated with the third content clip.

4. The method of claim 1, further comprising:
receiving, from the user device, a user input indicating selection of the third content clip; and
in response to receiving the user input, causing a third content item associated with the third content clip to begin being presented on the display associated with the user device.

5. The method of claim 1, wherein the first content clip is requested based on a search query entered on the user device.

6. The method of claim 1, further comprising:
receiving, from the user device, a second user input indicating that the second content clip is not to be presented;
in response to receiving the second user input, inhibiting presentation of the second content clip; and
receiving, from the user device, a third user input indicating that presentation of the second content clip is to resume, wherein the second content clip is presented on the display associated with the user device in response to receiving the third user input.

7. The method of claim 1, further comprising:
receiving, from the user device, a request to modify a duration of the third content clip from a first duration to a second duration prior to causing the third content clip to be presented;
in response to receiving the request, modifying the third content clip to be of the second duration;
causing the modified third content clip to be presented on the display associated with the user device; and
requesting a fourth content clip with the second duration.

8. A system for media guidance, the system comprising:
a hardware processor that is programmed to:
receive, from a user device, a request to browse through related content;
receive a plurality of content clips in response to receiving the request, wherein each content clip in the plurality of content clips corresponds to a portion of a corresponding content item, and wherein the plurality of content clips includes a first content clip and a second content clip that are each related to a particular topic;
cause the first content clip to be presented on a display associated with the user device;
in response to determining that presentation of the first content clip has been completed, cause the second content clip to be presented on the display associated with the user device;
receive, from the user device, a user input indicating a user preference related to the second content clip;
in response to receiving the user input, request a third content clip based on the user preference related to the second content clip;
receive, in response to the request, the third content clip, wherein the third content clip has been identified based at least in part on metadata associated with the second content clip and metadata associated with the third content clip; and
cause the third content clip to be presented on the display associated with the user device.

9. The system of claim 8, wherein a second content item corresponding to the second content clip and a third content item corresponding to the third content clip have been determined to be of similar durations.

10. The system of claim 8, wherein a second content item corresponding to the second content clip and a third content item corresponding to the third content clip have been determined to be associated with a particular genre of content based on the metadata associated with the second content clip and the metadata associated with the third content clip.

11. The system of claim 8, wherein the hardware processor is further programmed to:
receive, from the user device, a user input indicating selection of the third content clip; and
in response to receiving the user input, cause a third content item associated with the third content clip to begin being presented on the display associated with the user device.

12. The system of claim 8, wherein the first content clip is requested based on a search query entered on the user device.

13. The system of claim 8, wherein the hardware processor is further programmed to:
receive, from the user device, a second user input indicating that the second content clip is not to be presented;
in response to receiving the second user input, inhibit presentation of the second content clip; and
receive, from the user device, a third user input indicating that presentation of the second content clip is to resume, wherein the second content clip is presented on the display associated with the user device in response to receiving the third user input.

14. The system of claim 8, wherein the hardware processor is further programmed to:
receive, from the user device, a request to modify a duration of the third content clip from a first duration to a second duration prior to causing the third content clip to be presented;
in response to receiving the request, modify the third content clip to be of the second duration;
cause the modified third content clip to be presented on the display associated with the user device; and
request a fourth content clip with the second duration.

15. A non-transitory computer-readable medium containing computer executable instructions that, when executed by a processor, cause the processor to perform a method for media guidance, the method comprising:
receiving, from a user device, a request to browse through related content;
receiving a plurality of content clips in response to receiving the request, wherein each content clip in the plurality of content clips corresponds to a portion of a corresponding content item, and wherein the plurality of content clips includes a first content clip and a second content clip that are each related to a particular topic;
causing the first content clip to be presented on a display associated with the user device;
in response to determining that presentation of the first content clip has been completed, causing the second content clip to be presented on the display associated with the user device;
receiving, from the user device, a user input indicating a user preference related to the second content clip;
in response to receiving the user input, requesting a third content clip based on the user preference related to the second content clip;
receiving, in response to the request, the third content clip, wherein the third content clip has been identified based at least in part on metadata associated with the second content clip and metadata associated with the third content clip; and
causing the third content clip to be presented on the display associated with the user device.

16. The non-transitory computer-readable medium of claim 15, wherein a second content item corresponding to the second content clip and a third content item corresponding to the third content clip have been determined to be of similar durations.

17. The non-transitory computer-readable medium of claim 15, wherein a second content item corresponding to the second content clip and a third content item corresponding to the third content clip have been determined to be associated with a particular genre of content based on the metadata associated with the second content clip and the metadata associated with the third content clip.

18. The non-transitory computer-readable medium of claim 15, wherein the method further comprises:
receiving, from the user device, a user input indicating selection of the third content clip; and
in response to receiving the user input, causing a third content item associated with the third content clip to begin being presented on the display associated with the user device.

19. The non-transitory computer-readable medium of claim 15, wherein the first content clip is requested based on a search query entered on the user device.

20. The non-transitory computer-readable medium of claim 15, wherein the method further comprises:
receiving, from the user device, a second user input indicating that the second content clip is not to be presented;
in response to receiving the second user input, inhibiting presentation of the second content clip; and
receiving, from the user device, a third user input indicating that presentation of the second content clip is to resume, wherein the second content clip is presented on the display associated with the user device in response to receiving the third user input.

21. The non-transitory computer-readable medium of claim 15, wherein the method further comprises:
receiving, from the user device, a request to modify a duration of the third content clip from a first duration to a second duration prior to causing the third content clip to be presented;
in response to receiving the request, modifying the third content clip to be of the second duration;
causing the modified third content clip to be presented on the display associated with the user device; and
requesting a fourth content clip with the second duration.
